(19) United States
(12) Patent Application Publication
(10) Pub. No.: US 2025/0363572 A1
(43) Pub. Date: Nov. 27, 2025

(54) USER BEHAVIOR EVALUATION DEVICE

(71) Applicant: NTT DOCOMO, INC., Tokyo (JP)

(72) Inventors: Takuya IZUMISAWA, Chiyoda-ku (JP); Kouhei KISHI, Chiyoda-ku (JP); Takashi SUZUKI, Chiyoda-ku (JP); Akira YAMADA, Chiyoda-ku (JP)

(73) Assignee: NTT DOCOMO, INC., Tokyo (JP)

(21) Appl. No.: 18/873,785

(22) PCT Filed: May 31, 2023
(86) PCT No.: PCT/JP2023/020244

§ 371 Date: Dec. 11, 2024

(30) Foreign Application Priority Data
Aug. 18, 2022 (JP) 2022-130427

(51) Int. Cl. G06Q 50/10

(52) U.S. Cl. CPC G06Q 50/10

(57) ABSTRACT

An objective is to provide a user behavior evaluation device capable of ascertaining a degree of environmental contribution in accordance with a user.

According to the present disclosure, a sustainable score calculation device 100 includes a reduced-amount-of-emissions calculation portion 103 (environmental impact calculation portion) configured to calculate an amount of CO₂ (environmental impact) generated in association with the behavior of a target user and a score calculation portion 104 configured to derive a scoring coefficient on the basis of the target user or the behavior of the target user and calculate a sustainable score (evaluation value) for the behavior of the user on the basis of the amount of generated CO₂ and the scoring coefficient. The score calculation portion 104 has functions of a coefficient derivation portion and a behavior evaluation portion.

### TECHNICAL FIELD

The present invention relates to a user behavior evaluation device.

### BACKGROUND ART

To realize a sustainable society, it is essential for each individual to take behavior that contributes to environmental conservation (hereinafter referred to as “eco-behavior”), and it is necessary to ascertain a degree to which the eco-behavior of each individual contributes to the environment quantitatively.

Patent Literature 1 describes a method of calculating an amount of CO₂ emissions by multiplying an amount of used energy by a unit of CO₂ emissions of energy and comparing the calculated amount of CO₂ emissions with a reference amount of CO₂ emissions to calculate an amount of money corresponding to the amount of CO₂ emissions.

### CITATION LIST

### Patent Literature

[Patent Literature 1] Japanese Unexamined Patent Publication No. 2009-289171

### SUMMARY OF INVENTION

### Technical Problem

In the technique described in Patent Literature 1, it is possible to ascertain a degree of environmental contribution of behavior by calculating an amount of CO₂ emissions and an amount of money corresponding thereto. However, it is not possible to ascertain the amount of money in consideration of a user's circumstances, i.e., the degree of environmental contribution. Because an environmental contribution is obtained from sustainability, it is preferable to ascertain the degree of environmental contribution that is easy for each user to sustain in consideration of the user's circumstances. For example, the degree of environmental contribution differs according to a user's place of residence, family structure, and the like and it is preferable to ascertain the degree of environmental contribution in consideration thereof.

Therefore, to solve the above-described problem, an objective is to provide a user behavior evaluation device capable of ascertaining a degree of environmental contribution in accordance with a user.

### Solution to Problem

According to the present invention, a user behavior evaluation device includes an environmental impact calculation portion configured to calculate an amount of environmental impact generated in association with the behavior of a user; a coefficient derivation portion configured to derive a coefficient on the basis of the user or the behavior of the user; and a behavior evaluation portion configured to calculate an evaluation value for the behavior of the user on the basis of the generated amount and the coefficient.

### Advantageous Effects of Invention

According to the present invention, it is possible to evaluate the behavior of a user in accordance with the user's situation and circumstances.

### BRIEF DESCRIPTION OF DRAWINGS

FIG. 1 is a diagram showing a system configuration of a sustainable score calculation system 10.

FIG. 2 is a diagram showing a specific example of a moving behavior information DB 301.

FIG. 3 is a diagram showing a specific example of a communication plan information DB 302.

FIG. 4 is a diagram showing a specific example of an electricity information DB 303.

FIG. 5 is a diagram showing a specific example of a purchase information DB 304.

FIG. 6 is a block diagram showing a functional configuration of a sustainable score calculation device 100 of the present disclosure.

FIG. 7 is a flowchart showing an operation of the sustainable score calculation device 100.

FIG. 8 is a flowchart showing a detailed process of a processing step S103 of the sustainable score calculation device 100 using moving behavior information.

FIG. 9 is a diagram showing information obtained by adding a reduced amount of emissions and a score to the moving behavior information DB 301.

FIG. 10 is an explanatory diagram of a logic for calculating a reduced amount of CO₂ emissions of each moving means.

FIG. 11 is a flowchart showing a detailed process of a sustainer calculation processing step (S103) of the sustainable score calculation device 100 using communication plan information.

FIG. 12 is a diagram showing a specific example of storage data in a communication plan.

FIG. 13 is a flowchart showing a detailed process of the sustainer calculation processing step (S103) of the sustainable score calculation device 100 using electricity information.

FIG. 14 is a diagram showing a specific example of storage data in electricity information.

FIG. 15 is a flowchart showing a detailed process of the sustainer calculation processing step (S103) of the sustainable score calculation device 100 using purchase information.

FIG. 16 is a diagram showing a specific example of storage data for purchase information.

FIG. 17 is a diagram showing an example of a hardware configuration of the sustainable score calculation device 100 according to an embodiment of the present disclosure.

### DESCRIPTION OF EMBODIMENTS

Embodiments of the present disclosure will be described with reference to the accompanying drawings. If possible, identical parts are denoted by the same reference signs and redundant description will be omitted.

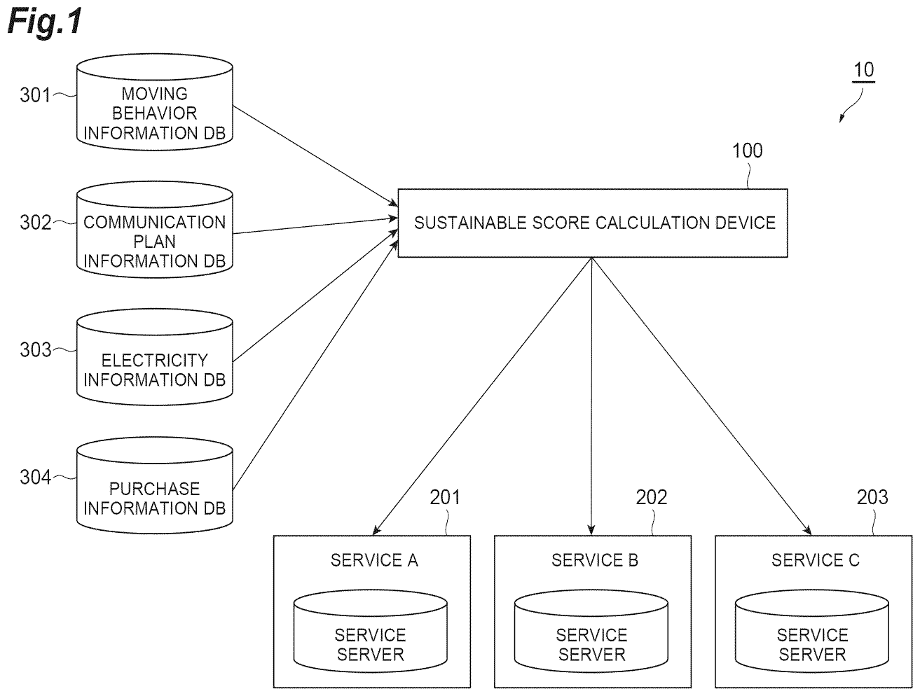

FIG. 1 is a diagram showing a system configuration of a sustainable score calculation system 10 including a sustainable score calculation device 100 of the present disclosure. As shown in FIG. 1, the sustainable score calculation system 10 is configured to include the sustainable score calculation device 100, various types of service servers 200 (201 to 203), and various types of databases 300 (301 to 304).

The sustainable score calculation device 100 is a user behavior evaluation device as a device for calculating a sustainable score for the behavior of a user. The sustainable score is numerical information indicating a degree of environmental contribution of the behavior of the user. Hereinafter, unless otherwise noted, the sustainable score is abbreviated as a score.

Moreover, the service server 200 includes service servers 201 to 203 that manage each of the services A to C. The services A to C include location information services, healthcare services, green 5G services, electricity supply services, shopping services, and the like. Although described in detail below, the service server 200 can obtain the sustainable score by requesting the sustainable score calculation device 100 to calculate the sustainable score. Each service server 200 notifies the user of a sustainable score in response to a request from the user. Moreover, for example, the service server 200 has a web server function, and the user may view the user's sustainable score by accessing the service server 200 using a terminal.

The various types of databases 300 are databases for storing a user behavior history. In the present disclosure, the various types of databases 300 include a moving behavior information DB 301, a communication plan information DB 302, an electricity information DB 303, and a purchase information DB 304.

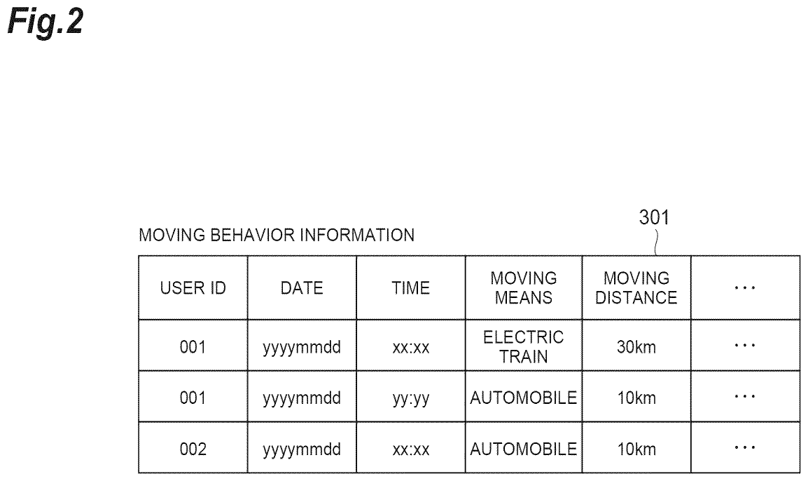

The moving behavior information DB 301 is a database that stores history information of the user's moving behavior. In the present disclosure, the user's moving behavior indicates a moving means and a moving distance. FIG. 2 is a diagram showing a specific example of the moving behavior information DB 301. As shown in FIG. 2, the moving behavior information DB 301 is associated with each moving means and stores by associating a user ID, a date, time, a moving means, and a moving distance. In the present disclosure, the moving means is estimated from location information of the user (location information of a portable terminal held by the user). This estimation process is performed in the service server 200 or another management server that manages the location information.

It is assumed that this date and time are the time at which movement began with a moving means. In other words, it can be considered as the date and time when a moving means was changed, but is not limited to that; it may also serve as a rough indication of the time period. Moreover, it may be the time at which the movement by the moving means ended.

Because the moving means is decided by estimation, incorrect estimation may be made. Therefore, when the moving means is estimated, a notification thereof may be provided to the user and modification may be performed by a manipulation of the user. When the notification of the score has been provided, it is possible to accept the modification of the moving means by the user.

The communication plan information DB 302 is a database for storing communication plan information of a portable phone for which the user has a contract. This communication plan information indicates a contract line type. In the present disclosure, the line type refers to a 4G line and a 5G line in a portable phone. In recent years, the base stations constituting 5G lines have been green base stations. This green base station is a base station that reduces the consumption of electric power supplied from commercial power sources and uses renewable energy such as solar power, and is a base station that has reduced environmental impact. Therefore, the communication plan information DB 302 may store information indicating whether or not it is contract content that enables environmental load reduction instead of a line type.

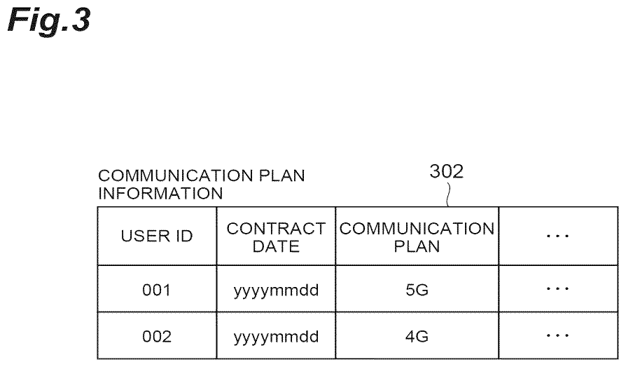

FIG. 3 is a diagram showing a specific example of the communication plan information DB 302. As shown in FIG. 3, a user ID, a contract date, and a communication plan are stored in association with each other. The communication plan is as described above, but may include other line types instead of or in addition to the 4G/5G line.

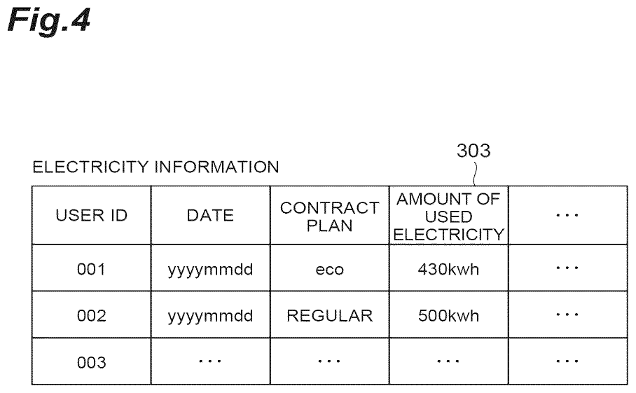

The electricity information DB 303 is a database storing the content of a contract made by the user with an electricity company. FIG. 4 is a diagram showing a specific example of the electricity information DB 303. The electricity information DB 303 stores a user ID, a date, a contract plan, and an amount of electricity in association with each other. It is indicated whether the contract plan is an ECO plan that reduces the environmental impact or a regular plan. As a power generation mechanism to reduce the environmental impact, there is a mechanism in which an amount of CO₂ emissions is extremely small or zero and there is a mechanism that uses renewable energy such as solar power generation. The ECO plan is such a plan to reduce environmental impact.

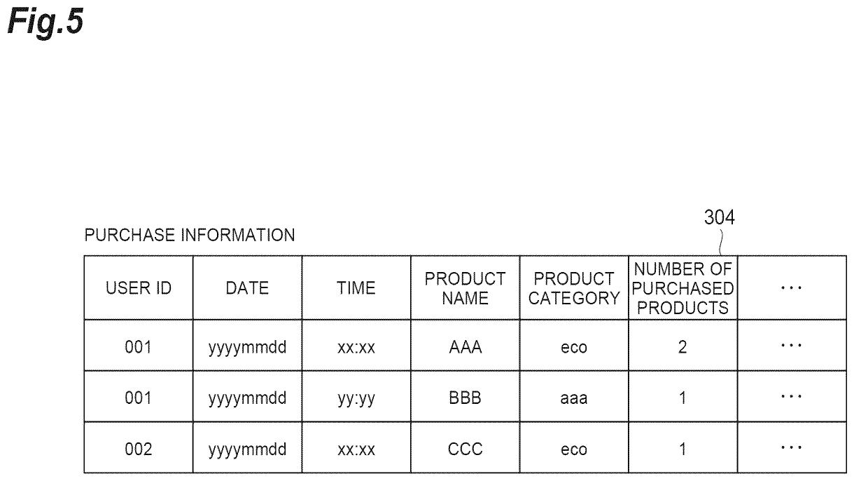

The purchase information DB 304 is a database storing a product purchased by the user and a purchase method. FIG. 5 is a diagram showing a specific example of the purchase information DB 304. As shown in FIG. 5, the purchase information DB 304 stores a user ID, a date/time of purchase, a product name, a product category, and the number of purchased products in association with each other. The product category is information indicating whether or not a product is eco-friendly. Instead of the product category, the product name may indicate whether or not a product is eco-friendly. Eco-friendly products are products that have an amount of CO₂ emissions that is extremely small or zero in their production. In addition to this, it may also be a product that reduces an amount of CO₂ emissions by its use.

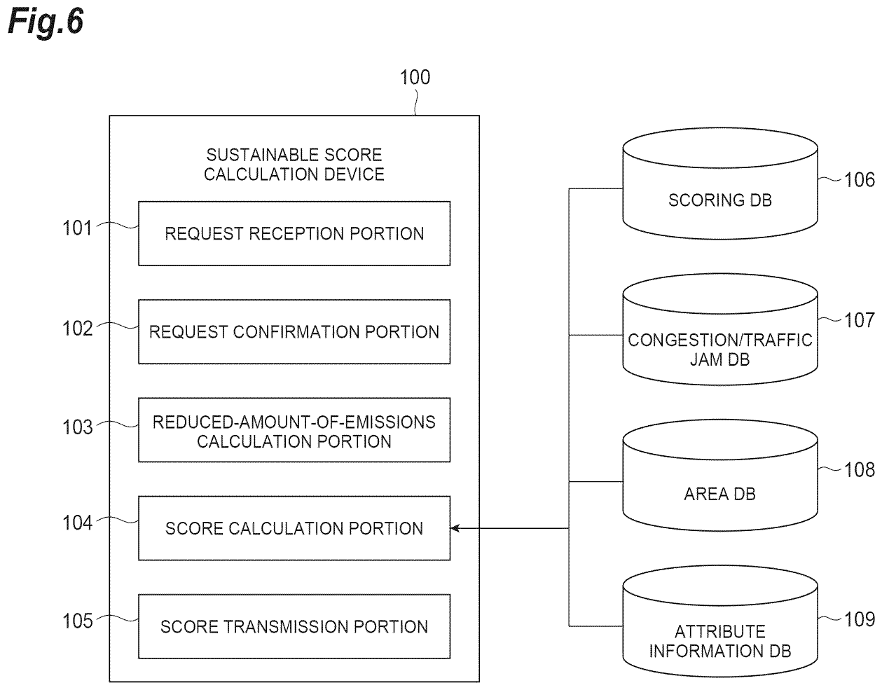

FIG. 6 is a block diagram showing a functional configuration of the sustainable score calculation device 100 of the present disclosure. As shown in FIG. 6, the sustainable score calculation device 100 is configured to include a request reception portion 101, a request confirmation portion 102, a reduced-amount-of-emissions calculation portion 103, a score calculation portion 104, and a score transmission portion 105.

The request reception portion 101 is a portion configured to receive score calculation requests from the service servers 201 to 203.

The request confirmation portion 102 is a portion configured to confirm a service server 200 from which a request is issued (a request source) and a target user. The request confirmation portion 102 performs a process of accessing each DB 200 and extracting data.

The reduced-amount-of-emissions calculation portion 103 is a portion configured to acquire the behavior information of the target user from the extracted data and calculate a reduced amount of CO₂ emissions. Details will be described below. The reduced-amount-of-emissions calculation portion 103 associates the calculated reduced amount of CO₂ emissions with the user ID and stores an association result in the storage data.

The score calculation portion 104 is a portion configured to calculate a score in accordance with the reduced amount of CO₂ emissions. The score calculation portion 104 associates the calculated score with the user ID and stores an association result in the storage data.

The score transmission portion 105 is a portion configured to transmit the score of the storage data to the service server 200 issuing the request. In addition, the score transmission portion 105 may directly transmit to a terminal of the target user who is a score calculation target.

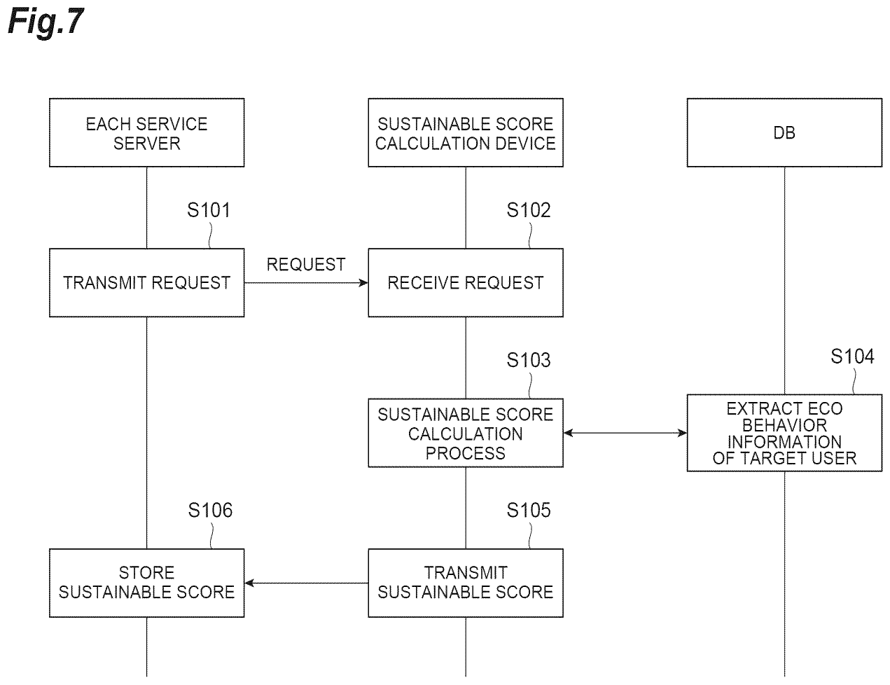

Next, an operation of the sustainable score calculation device 100 configured in this way will be described. FIG. 7 is a flowchart showing the operation. The service server 200 transmits a request to the sustainable score calculation device 100 (S101).

In the sustainable score calculation device 100, the request reception portion 101 receives a request (S102).

The request confirmation portion 102 confirms the request content (a target user and a service) and acquires necessary data from each database 300. Also, the reduced-amount-of-emissions calculation portion 103 calculates the reduced amount of CO₂ emissions and the score calculation portion 104 calculates the sustainable score (S103). In this sustainable score calculation process, the scoring coefficient changes in accordance with the user's environment and circumstances, and the sustainable score can be obtained in accordance with the user's environment and the like. Moreover, depending on the user's behavior, the database 300 accessed by the service server 200 changes. Details of these sustainable score calculation processes will be described separately.

The database 300 extracts the behavior information of the target user in response to an inquiry from the sustainable score calculation device 100 and returns the behavior information (S104).

The score transmission portion 105 transmits the calculated sustainable score to the service server 200 (S105). Although the calculated sustainable score is transmitted to the service server 200 issuing the request in FIG. 7, the present invention is not limited thereto. The calculated sustainable score may be transmitted directly to the target user's terminal related to the score.

The service server 200 stores the sustainable score transmitted from the sustainable score calculation device 100 (S106).

Next, a sustainable score calculation process will be described separately for each service.

### <Location Information Service>

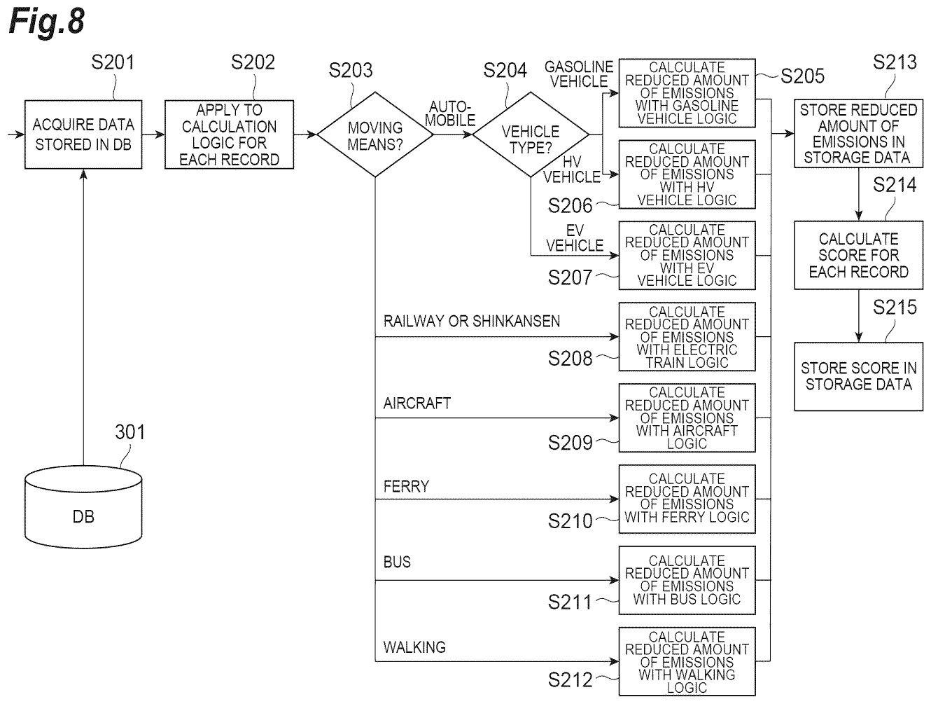

FIG. 8 is a flowchart showing a detailed process of the processing step S103 in FIG. 7. Specifically, the flowchart shows an operation when the sustainable score calculation device 100 accesses the moving behavior information DB 301 and calculates the sustainable score.

When the request reception portion 101 receives the request, the request confirmation portion 102 confirms the target user and the target service. Also, the request confirmation portion 102 accesses the moving behavior information DB 301 and acquires the stored data (S201). Also, the reduced-amount-of-emissions calculation portion 103 acquires data for each record and applies the data to a calculation logic (S202). Also, the reduced-amount-of-emissions calculation portion 103 determines a moving means and a vehicle type included in each record (S203 and S204). In addition, the record here shows a data string for each user's moving means.

Also, the reduced-amount-of-emissions calculation portion 103 determines means is an automobile, a railway/Shinkansen, an aircraft, a ferry, a bus, walking, or the like (S203). In addition, these moving means are examples and do not exclude other moving means such as motorcycles.

When the reduced-amount-of-emissions calculation portion 103 determines that it is an automobile, it is further determined whether the vehicle type is a gasoline vehicle, a hybrid vehicle (HV) vehicle, an electric vehicle (EV) vehicle, or the like (S204). Here, gasoline vehicles, HV vehicles, EV vehicles, and the like are cited as examples, but the present invention is not limited thereto.

The reduced-amount-of-emissions calculation portion 103 calculates a reduced amount of emissions in accordance with the reduced-amount-of-emission calculation logic corresponding to the moving means and vehicle type (S205 to S212).

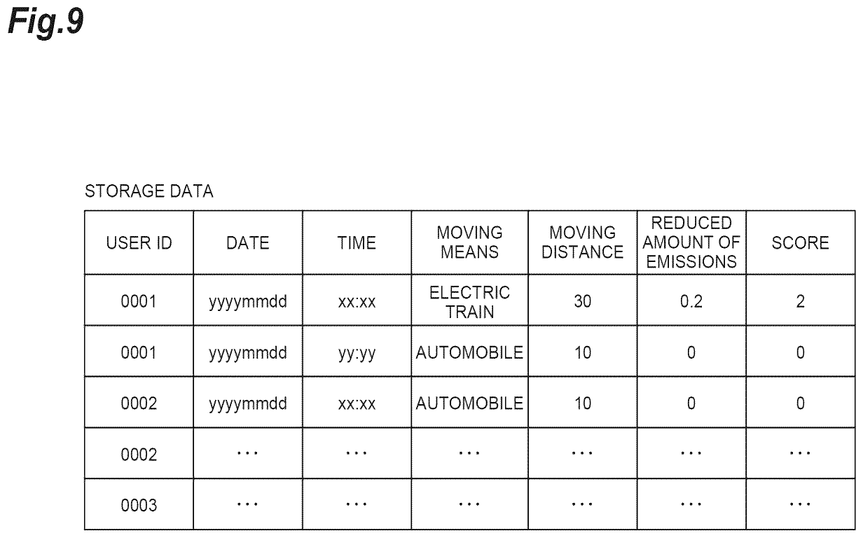

The reduced-amount-of-emissions calculation portion 103 stores the calculated reduced amount of emissions in the storage data. The storage data is information obtained by adding the reduced amount of emissions and the score to the moving behavior information DB 301. FIG. 9 is a diagram showing a specific example. The reduced-amount-of-emissions calculation portion 103 iterates the processing steps of S203 to S213 for each record, calculates the reduced amount of emissions for each record, and stores the calculated reduced amount of emissions in the storage data (S213).

The score calculation portion 104 calculates a score on the basis of a reduced amount of emissions for each record (S214). The score calculation portion 104 stores the calculated score in the storage data (S215). In the example of FIG. 9, the scoring coefficient is set to 10. For example, the reduced amount of CO₂ emissions is 0.2×Scoring coefficient 10=Score 2.

Thus, according to a request from each service server 200, the reduced amount of CO₂ emissions of the target user is calculated, and a score based on the calculated reduced amount of CO₂ emissions is calculated.

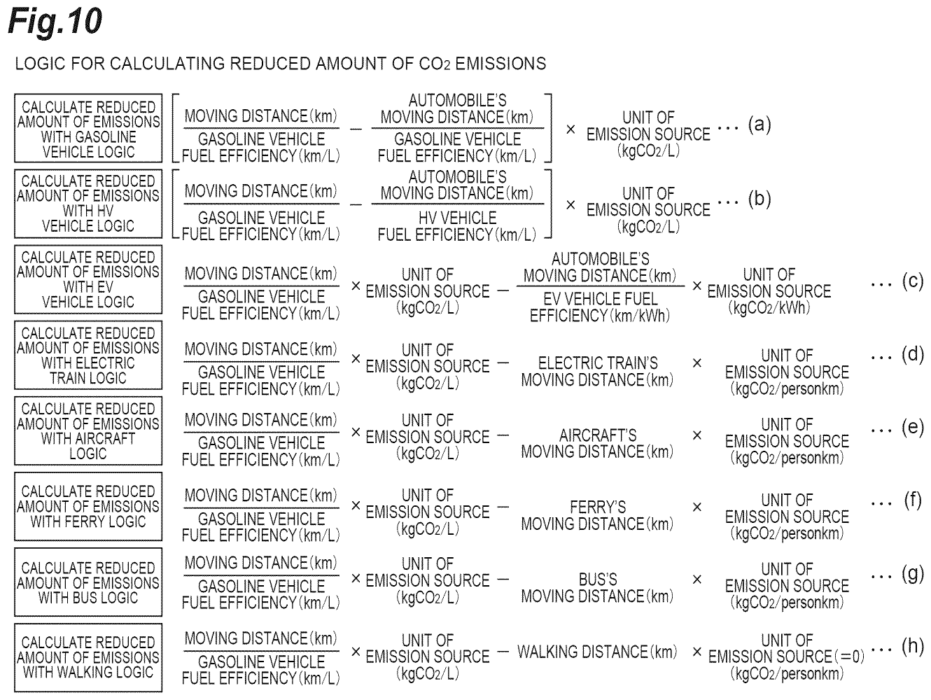

Next, a calculation logic in which the service server 200 calculates a reduced amount of CO₂ emissions based on the location information service will be described. FIG. 10 is an explanatory diagram of the calculation logic for the reduced amount of CO₂ emissions for each moving means. As shown in FIG. 10, a reduced amount of CO₂ is calculated on the basis of a moving distance of a gasoline vehicle. Here, the gasoline vehicle is used as the standard. However, as the times change, the standard moving means also change. For example, HV vehicles may become the standard in the future.

First, the reduced amount of emissions is calculated in a gasoline vehicle logic. In the present disclosure, (moving distance/gasoline vehicle fuel consumption−automobile moving distance/gasoline vehicle fuel consumption)*unit of emission source (kgCO₂/L) is determined. The “moving distance” in this expression is a distance when it is assumed that all of one's own movement has been performed by the gasoline vehicle. For example, even in the case of movement using walking and the gasoline vehicle, the distance is a distance when it is assumed that all movement has been performed using the gasoline vehicle.

Eq. (a) in FIG. 10 is an equation for calculating a reduced amount of emissions by subtracting an amount of CO₂ emissions during the movement of the actual distance using a gasoline vehicle from an amount of CO₂ emissions during the movement of the entire distance using the gasoline vehicle. Likewise, for Eqs. (b) to (h), the reduced amount of CO₂ emissions using each moving means can be calculated by subtracting an amount of CO₂ emissions during the movement using each means from an amount of CO₂ emissions during the movement using the gasoline vehicle.

In addition, the unit of emission source in Eqs. (c) to (g) is a unit obtained by performing conversion into an amount of CO₂ emissions per person because it is a vehicle that can be boarded by multiple people, such as a train. Because Eq. (h) is related to walking, the unit of emission source is 0.

A score is obtained by multiplying this reduced amount of CO₂ emissions by a predetermined scoring coefficient. Although an amount of CO₂ emissions during the use of a gasoline vehicle is used as the standard in the above description, the present invention is not limited thereto. For example, when it is desired to obtain a score at the time of commuting of the user and a score at the time of another periodically performed movement, a commuting means or a moving means used by the user is estimated from location information or the like, and an amount of CO₂ emissions of the commuting means or the moving means may be used as a standard. The commuting means or the moving means is estimated from location information according to known technology.

Next, a scoring coefficient will be described. The scoring coefficient may be a fixed value, but may be variable according to a situation or circumstances in which the user is located, as follows.

The sustainable score calculation device 100 (the score calculation portion 104) may decide a scoring coefficient in consideration of the congestion/traffic jam situation on a route along which the target user has moved. For example, when a traffic jam occurs in an area around the target user's movement route and the user moves using a moving means other than a private car, the scoring coefficient may be lower than in normal times. This is because when the average vehicle speed decreases due to a traffic jam, an amount of CO₂ emissions increases.

The sustainable score calculation device 100 capable of accessing a scoring DB and a traffic jam DB (not shown) that stores congestion/traffic jam situations is configured. This traffic jam DB stores congestion/traffic jam situations for each time period on each road and store obtained by known technology. Moreover, the scoring DB stores a scoring coefficient according to the congestion/traffic jam situations. For example, the congestion/traffic jam situations are expressed in three stages, such as smoothness, congestion, and traffic jam. The scoring coefficient is changed according to each situation. For example, the scoring coefficient is set to be high if the situation is smooth and the scoring coefficient is set to be lower as an amount of CO₂ emissions increases as in the congestion and traffic jam.

More specifically, the score calculation portion 104 acquires a congestion/traffic jam situation around the target user's location during a time period indicated by the date and time in the target user's storage data from the traffic jam DB.

Also, the score calculation portion 104 acquires a scoring coefficient from the scoring DB on the basis of the congestion/traffic jam situation. Also, the score calculation portion 104 calculates a sustainable score on the basis of the reduced amount of CO₂ emissions and the scoring coefficient.

Thereby, the scoring coefficient is variably set in accordance with an environment/situation in which the user is placed. For example, when the car is to be moved in a situation where an amount of CO₂ emissions is large, a process in which the scoring coefficient is set to be low and the sustainable score is lowered is performed.

By referring to the traffic jam database, the score calculation portion 104 extracts a scoring coefficient corresponding to the congestion/traffic jam situation of the route passed by the user and calculates a score based on the reduced amount of CO₂ emissions using this scoring coefficient.

Moreover, the score calculation portion 104 may decide a scoring coefficient in accordance with an area where the target user is located. For example, the scoring coefficient may be set to be low in a metropolitan area where there is enough public transportation and there are few users using private cars and the scoring coefficient may be set to be high in a rural area where there are many users using private cars.

That is, the sustainable score calculation device 100 (the score calculation portion 104) capable of accessing an area DB (not shown) in which an area and a scoring coefficient are stored in association is configured. Also, the score calculation portion 104 acquires a scoring coefficient corresponding to the area where the target user is located, and calculates a score of the reduced amount of CO₂ emissions using the scoring coefficient.

Moreover, the score calculation portion 104 may decide the scoring coefficient according to the age and family structure of the target user. For example, for family households, the scoring coefficient may be set to be high.

Specifically, the score calculation portion 104 capable of accessing the attribute information DB 109 is configured. The attribute information DB 109 stores attribute information such as the user's age, family structure, place of residence, gender, and occupation. The scoring DB 106 stores a scoring coefficient corresponding to the user's attribute information. The score calculation portion 104 extracts the attribute information of the target user from the attribute information DB 109 and extracts a scoring coefficient corresponding to the attribute information from the scoring DB 106. The score calculation portion 104 calculates a sustainable score on the basis of this scoring coefficient.

The score calculation portion 104 can decide the scoring coefficient with reference to the information. In addition, the above-described scoring coefficient may be set in combination. For example, a scoring coefficient may be obtained by combining a traffic jam situation, an area, and an attribute (a family structure or the like). For example, the scoring coefficient is defined in the scoring DB in accordance with the attribute, area, and situation.

When the target user is in a traffic jam in a certain area (such as a suburban area) with a predetermined family structure (such as a large family), a corresponding scoring coefficient can be obtained. This is because it is necessary to move by car in the case of a large family and it is necessary to make an adjustment such as setting a high scoring coefficient in that case.

### <Communication Plan Information>

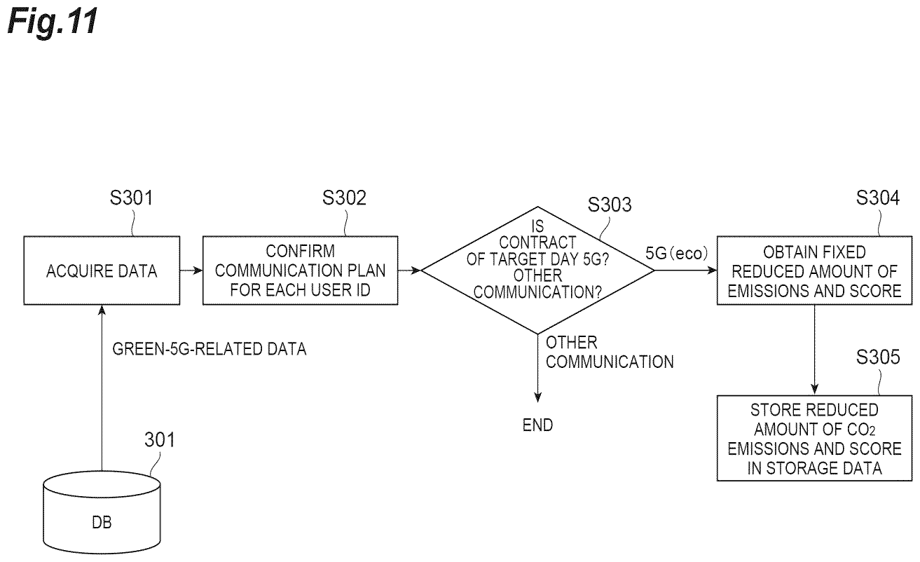

Next, the logic for calculating the reduced amount of CO₂ emissions corresponding to the contract content (communication plan) of the portable terminal used by the user will be described. FIG. 11 is a flowchart showing a detailed process of a sustainer calculation processing step (S103) of the sustainable score calculation device 100.

When the request reception portion 101 receives a request from the service server 202 that manages the user's communication plan (S102), the request confirmation portion 102 extracts data from the communication plan information DB 302 (S301). The request confirmation portion 102 checks the extracted data for each user ID and confirms the communication plan of each user (S302).

The request confirmation portion 102 confirms content of each user's communication plan (S303). Here, the request confirmation portion 102 determines whether the contract content is 5G communication or other communication (for example, 4G communication).

When it is determined that the contract content is 5G communication, the reduced-amount-of-emissions calculation portion 103 acquires a predetermined reduced amount of CO₂ emissions (for example, stored in a built-in memory) associated with the 5G communication. The score calculation portion 104 calculates a score on the basis of the reduced amount of CO₂ emissions (S304). Also, the reduced-amount-of-emissions calculation portion 103 and the score calculation portion 104 store the reduced amount of emissions and the score in the storage data (S305).

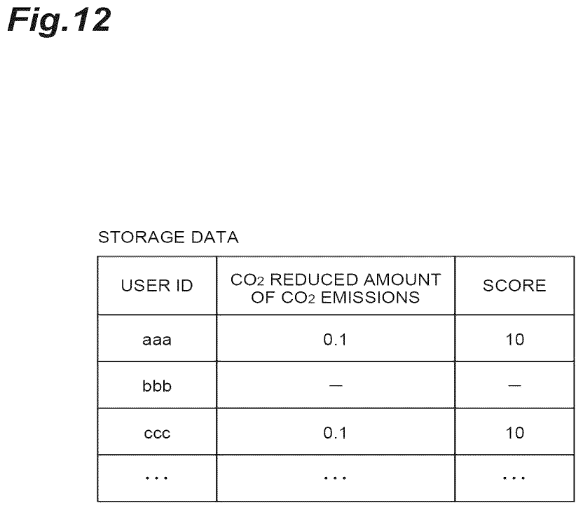

FIG. 12 is a diagram showing a specific example of storage data when communication plan information is used. As shown in FIG. 12, the reduced amount of CO₂ emissions and the score are associated with each user ID.

According to this process, it is possible to calculate a score for users who have made a contract for a service that works to reduce the emission of CO₂ of a company such as green 5G. Moreover, when it is possible to calculate the reduced amount of CO₂ emissions per person due to the use of the target service, this may be presented to the user.

Although a fixed reduced amount of CO₂ emissions is required for users who have made a contract for a 5G communication plan using green power (renewable energy) in the above description, the present invention is not limited thereto. For example, in accordance with an amount of communication of each user, an amount of CO₂ emissions that is substantially reduced may be estimated and used for scoring. The amount of communication is assumed to be an amount of communication within a predetermined time (for example, within 24 hours) retroactive to the time when the request was made, but is not limited thereto. Moreover, when a score corresponding to the amount of communication is obtained, the communication plan information DB 302 associates scores with amounts of communication of users. At this time, an amount of data distinguished between a voice call and data communication may be stored. The reduced-amount-of-emissions calculation portion 103 calculates the reduced amount of CO₂ emissions and its score on the basis of these amounts of communication.

Although a fixed reduced amount of CO₂ emissions is obtained in the processing step S304, the present invention is not limited thereto. According to the amount of communication during a predetermined period back from the date of the request, an amount of CO₂ emissions when it is assumed that there was a regular plan may be obtained. In this case, the amount of CO₂ emissions becomes a reduced amount of CO₂ emissions. A score may be obtained by multiplying the reduced amount of CO₂ emissions by a predetermined scoring coefficient. Moreover, the scoring coefficient may be set to be high in accordance with the reduced amount of CO₂ emissions.

### <Electricity Information>

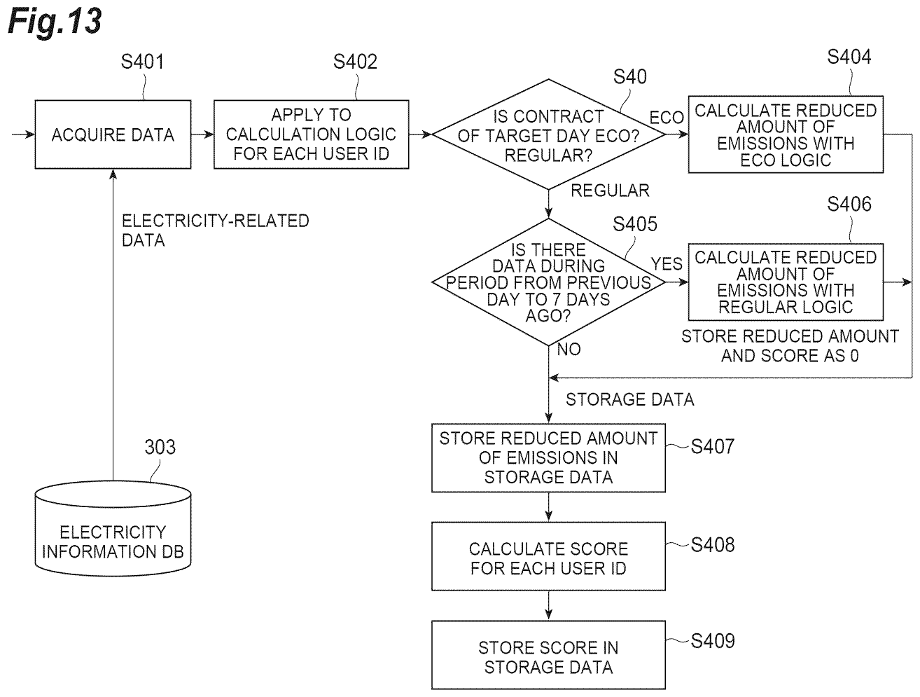

Next, a logic for calculating the reduced amount of CO₂ emissions according to electricity information will be described. FIG. 13 is a flowchart showing a detailed process of the sustainer calculation processing step (S103) of the sustainable score calculation device 100 using the electricity information.

When the request reception portion 101 receives a request from the service server 200 (S102), the request confirmation portion 102 extracts data from the electricity information DB 303 (S401). The request confirmation portion 102 acquires data for each record (S402) and determines whether the basic contract content of electricity use on a target date is an ECO contract or a regular contract (S403). The target date here is assumed to be the date on which the request is made. When it is determined that the basic contract content is the ECO (ecology: environmentally friendly) contract (S403: ECO), the reduced-amount-of-emissions calculation portion 103 calculates the reduced amount of emissions with an ECO logic (S404).

The ECO logic is based on the following calculation equation (1).

$$Reduced amount of emissions = Electricity consumption ( kWh ) \times Unit of emission source ( {kgCO}_{2} / kWh ) \qquad ( 1 )$$

In the case of the regular contract (S403: regular), the request confirmation portion 102 further determines whether there is data during a predetermined period (in this case, 7 days) retroactively from the target date (S405). When there is data, the reduced-amount-of-emissions calculation portion 103 calculates the reduced amount of emissions with a regular logic (S406).

The regular logic is based on the following calculation equation (2).

$$Reduced amount of emissions = ( ( Total electricity consumption / number of days with data during a period from the previous day to 7 days ago ) - Electricity consumption on the day ( kWh ) ) \times Unit of emission source ( {kgCO}_{2} / kWh ) \qquad ( 2 )$$

In addition, instead of the above regular logic and ECO logic, calculation may be performed by daily reducing the average electricity consumption/day per ECO plan contractor, and the score for the regular plan contractor may not be calculated.

The reduced-amount-of-emissions calculation portion 103 stores the reduced amount of emissions calculated in the processing step S404 and the processing step S406 in the storage data (S407). Moreover, when there is no data, the reduced-amount-of-emissions calculation portion 103 stores the reduced amount of emissions and the score as 0 in the storage data (S407).

The score calculation portion 104 calculates a score on the basis of the reduced amount of emissions for each user ID (S408). The score calculation portion 104 stores the calculated score in the storage data (S409).

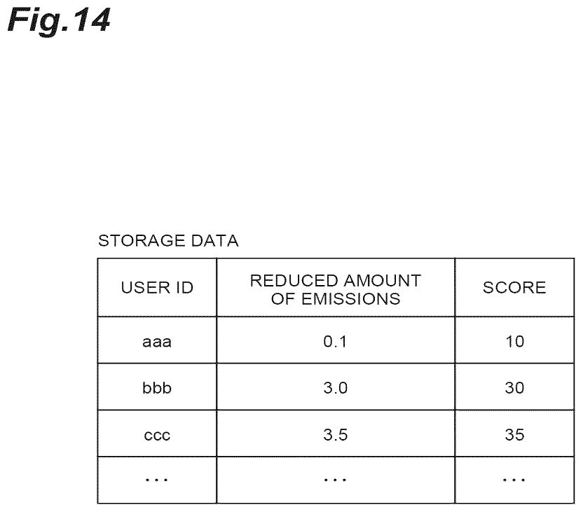

FIG. 14 is a diagram showing a specific example of storage data for electricity information. As shown in FIG. 14, the reduced amount of emissions and its score are associated with each user ID. The score transmission portion 105 transmits the score of the storage data to the service server 200.

In this way, for the regular contract, the reduced amount can be calculated by comparing the average electricity consumption of the previous week with the electricity consumption of the day. On the other hand, in the ECO contract, the amount of CO₂ emissions in the case of the regular contract is designated as a standard and it can be considered that all of the CO₂ emissions corresponding to the amount have been reduced. The score is obtained by multiplying the reduced amount of CO₂ emissions by a scoring coefficient α. When the score is calculated, the scoring coefficient may be changed according to attributes such as each user's age, family structure, and place of residence. Thereby, it is possible to perform sustainable activities in which scores can be obtained according to the user's home environment and other circumstances.

In addition, the sustainable score calculation device 100 acquires a scoring coefficient corresponding to the user from an attribute information DB (not shown) associated with the user's age, family structure, and place of residence, and a scoring DB associated with attribute information and a scoring coefficient.

Moreover, the score calculation portion 104 may decide the scoring coefficient in accordance with the area. For example, in the scoring DB 107, because electricity consumption is higher than in other areas such as Hokkaido in winter and Okinawa in summer, the scoring coefficient may be set to be high or low in accordance with characteristics of the area.

That is, the score calculation portion 104 accesses an attribute information DB 109 and an area DB 108 to acquire a place of residence of the target user. Also, a scoring coefficient is obtained with reference to the scoring DB 106. In the scoring DB 106, a scoring coefficient related to electricity information is associated with each area.

Likewise, the scoring DB 106 stores the scoring coefficient in accordance with the age and family structure. For example, the scoring coefficient is set to be higher for family households because they use more electricity than single-person households.

Moreover, the score calculation portion 104 may decide a scoring coefficient on the basis of a situation of the target user, such as whether or not the target user is working at home. For example, if the target user continues to be in the vicinity of the home in the terminal location during the daytime hours (referring to the location information DB), it is determined that the user is working at home. This determination is made by a management server (not shown). In the scoring DB 106, the scoring coefficient may be set to be high when the user is working at home. Moreover, the system operator may determine the situation of the user based on the self-declaration of the target user.

The score calculation portion 104 of the sustainable score calculation device 100 calculates the sustainable score using a scoring coefficient set to be high when the target user continues to stay in the vicinity of the home or the like (for example, working at home or the like) with reference to the moving behavior information DB 301.

The user state determination device (not shown) that registers information in the moving behavior information DB 301 can determine the user's stay state and determine the state in addition to determining the user's moving means and the like on the basis of the user's location information. When it is determined that the user is staying at home during the day, it is determined that the user is working at home and information indicating that the user is working at home is stored in the moving behavior information DB 301.

Thus, there are circumstances in which the user must be at home during the day. In this case, a sustainable score corresponding to the user's circumstances can be calculated by setting the scoring coefficient to a high coefficient.

### <Purchase Information>

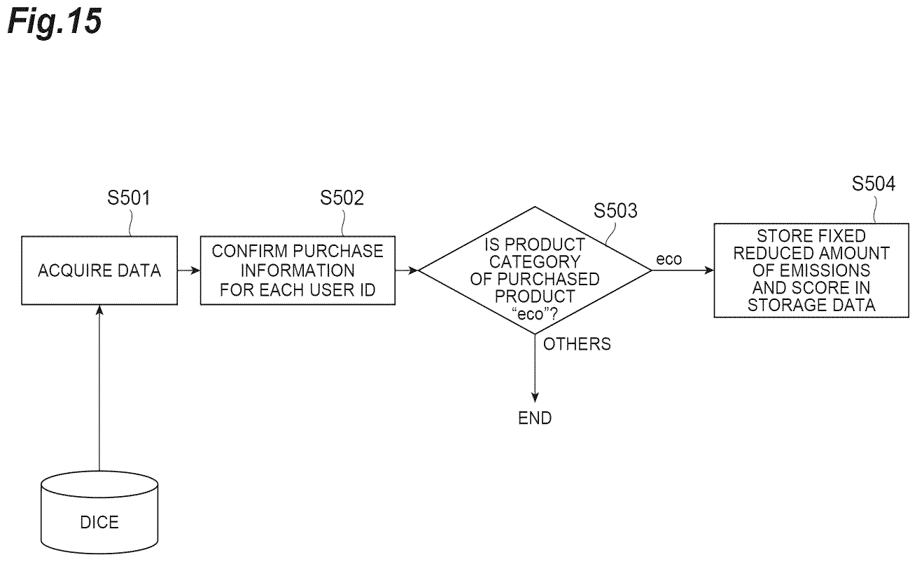

Next, the logic for calculating the reduced amount of CO₂ emissions according to the purchase information will be described. FIG. 15 is a flowchart showing a detailed process of the sustainer calculation processing step (S103) of the sustainable score calculation device 100 using purchase information.

When the request reception portion 101 receives a request from the service server 200 (S102), the request confirmation portion 102 extracts data from the purchase information DB 304 (S501). The request confirmation portion 102 confirms purchase information for each user ID (S502). The request confirmation portion 102 determines whether or not a product category of the purchased product is an ECO product (S503). When it is determined that the product category is an ECO product, the reduced-amount-of-emissions calculation portion 103 calculates a fixed reduced amount of emissions designated in advance and the score calculation portion 104 calculates a score corresponding to the reduced amount of emissions and stores the calculated score in the storage data for the purchase information (S505).

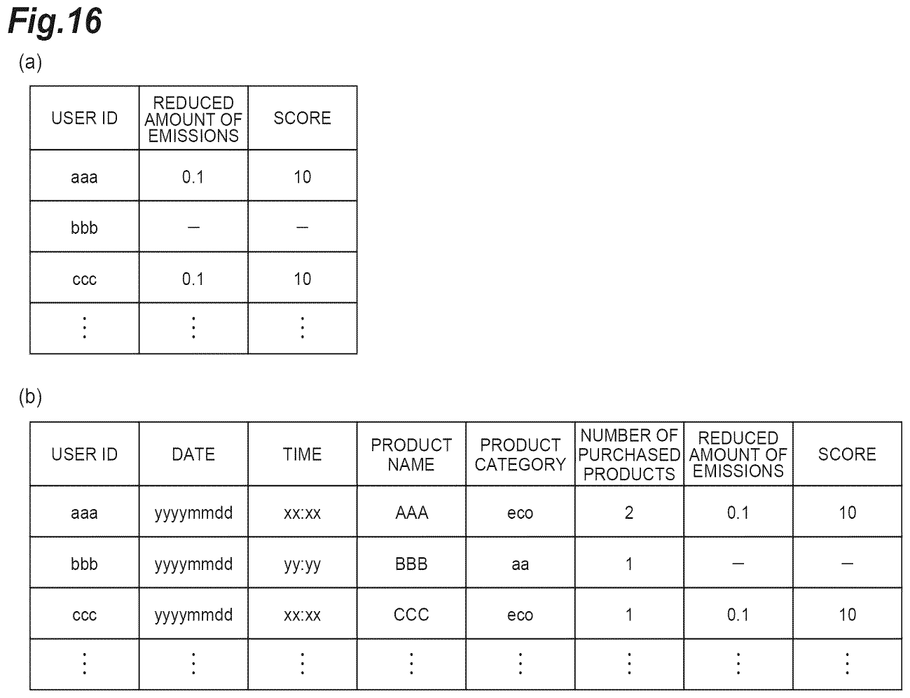

FIG. 16 is a diagram showing a specific example of the storage data for the purchase information. As shown in FIG. 16(a), the storage data is stored by associating the reduced amount of CO₂ emissions and the score for each user ID.

In addition, a score may be calculated from the reduced amount of CO₂ emissions reduced in accordance with the purchased product category and the number of purchased products and the storage data may be stored in associated with the score.

The reduced-amount-of-emissions calculation portion 103 or the score calculation portion 104 adds a score in accordance with the number of purchased products. For example, when the user purchases a plurality of ECO products, a score is calculated by adding up the reduced amounts of CO₂ emissions.

In this way, the reduced amount of CO₂ emissions can be obtained in accordance with the purchase of a predetermined category product in the purchase information.

Meanwhile, the purchase information in the present disclosure is purchase information for home delivery products in online shopping, telephone shopping, and the like. Therefore, the purchase of multiple products in a single purchase is considered to contribute to the reduction of CO₂ emissions. Therefore, the reduced-amount-of-emissions calculation portion 103 or the score calculation portion 104 may operate to add a score in accordance with the number of purchased products in one purchase. For example, the scoring coefficient is set to be high for each number of purchased products.

### REGARDING OTHER MODIFIED EXAMPLES

The sustainable score calculation device 100 of the present disclosure may have an event-driven format in which a request from each service server 200 is triggered by a trigger or a time-driven format in which the stored information of each DB is automatically referred to in batches at a predetermined time (for example, at night).

When the calculated value is stored in each service server 200, the sustainable score calculation device 100 may store not only the score but also the data used for the calculation. For example, the data may be an amount of CO₂ emissions, a reduced amount thereof, the moving means, and the like.

The above-described scoring coefficient may be freely decided by the business operator for each service of a calculation target.

Next, the action effect of the sustainable score calculation device 100 of the present disclosure will be described. The sustainable score calculation device 100 of the present disclosure includes a reduced-amount-of-emissions calculation portion 103 (environmental impact calculation portion) configured to calculate the amount of CO₂ (environmental impact) generated in association with the behavior of a target user and a score calculation portion 104 configured to derive a scoring coefficient on the basis of the target user or the behavior of the target user and calculate a sustainable score (evaluation value) for the behavior of the user (movement, use of electricity, a contract, a purchase, and the like) on the basis of the amount of generated CO₂ and the scoring coefficient. The score calculation portion 104 has functions of a coefficient derivation portion and a behavior evaluation portion. Although the reduced-amount-of-emissions calculation portion 103 calculates a sustainable score on the basis of the reduced amount of CO₂ emissions in the above-described disclosure, a sustainable score based only on an amount of CO₂ emissions may be calculated.

According to this configuration, an appropriate scoring coefficient can be derived on the basis of the target user or the behavior of the target user. Therefore, the user's behavior can be appropriately evaluated. For example, the user's behavior may not be suitable for the environment, but the behavior may be unavoidable depending on the environment and circumstances in which the user is placed. In the sustainable score calculation device 100 of the present disclosure, an evaluation for the user can be appropriately performed in consideration of the environment and circumstances of such a user.

Moreover, in the sustainable score calculation device 100 of the present disclosure, the reduced-amount-of-emissions calculation portion 103 further calculates the reduced amount of CO₂ on the basis of the generated amount and the score calculation portion 104 further calculates a sustainable score on the basis of the reduced amount of CO₂ emissions.

Thereby, it is possible to evaluate the user on the basis of the reduced amount of CO₂ emissions.

In the present disclosure, the behavior of the user includes at least one of movement of the user using a moving means, communication of a communication means used by the user, use of electricity by the user, and the purchase behavior of the user.

These behaviors are significantly related to amounts of CO₂ emissions and are appropriate for evaluating the behavior of the user.

In the present disclosure, the score calculation portion 104 derives a scoring coefficient on the basis of attributes of the user. The attributes of the user include at least one of a gender, age, place of residence, household type, and occupation of the user.

In accordance with these attributes of the user, the amount of CO₂ emissions of the user often changes. For example, an amount of used electricity of the single-person household is small, while an amount of used electricity of the family household is large. In consideration of this, the score calculation portion 104 can evaluate the appropriate behavior of the user by deriving a scoring coefficient. For example, when the user is involved in a traffic jam and is using a car, the amount of CO₂ emissions increases. Therefore, in this case, an appropriate evaluation is performed by adjusting the scoring coefficient so that the sustainable score is small.

Moreover, in the present disclosure, the score calculation portion 104 derives a coefficient corresponding to the situation in which the user is placed. For example, the score calculation portion 104 derives a scoring coefficient on the basis of the moving means (such as using a car) in the user's specific state (a traffic jam on commuting to work and school).

Because an amount of CO₂ emissions is expected to increase when the user moves with his or her own car in a specific state, the scoring coefficient is increased for the movement of the car under such circumstances.

The reduced-amount-of-emissions calculation portion 103 of the present disclosure calculates an amount of environmental impact generated in a unit of movement (for example, movement during commuting), and the score calculation portion 104 evaluates the behavior of the user in the unit of movement. Thereby, an evaluation can be performed for each movement of the user.

The score calculation portion 104 of the present disclosure derives the coefficient corresponding to an amount of communication of the user when a contract for a predetermined plan, which is a communication plan, is made as the behavior of the user. For example, if the user makes a contract for a 5G communication plan, the scoring coefficient is set to be high in accordance with the amount of communication of the user. Because the power consumption of the 5G communication plan is substantially zero, it is preferable to increase the score according to the amount of communication.

The score calculation portion 104 of the present disclosure derives a coefficient corresponding to the number of purchased products of a predetermined category as the behavior of the user. Thereby, it is possible to obtain a score according to the reduced amount of CO₂ emissions. By purchasing multiple products at the same time, an amount of CO₂ emissions for the delivery of products is reduced.

The user behavior evaluation device disclosed herein comprises the following components.

[1]

A user behavior evaluation device comprising:
an environmental impact calculation portion configured to calculate an amount of environmental impact generated in association with the behavior of a user;
a coefficient derivation portion configured to derive a coefficient on the basis of the user or the behavior of the user; and
a behavior evaluation portion configured to calculate an evaluation value for the behavior of the user on the basis of the generated amount and the coefficient.
   [2]

The user behavior evaluation device according to [1],
wherein the environmental impact calculation portion further calculates a reduced amount of environmental impact on the basis of the generated amount, and
wherein the behavior evaluation portion further calculates the evaluation value on the basis of the reduced amount.
   [3]

The user behavior evaluation device according to [1] or [2], wherein the behavior of the user includes at least one of movement of the user using a moving means, communication of a communication means used by the user, use of electricity by the user, and purchase behavior of the user.

[4]

The user behavior evaluation device according to any one of [1] to [3], wherein the coefficient derivation portion derives a coefficient on the basis of attributes of the user.

[5]

The user behavior evaluation device according to [4], wherein the attributes include at least one of a gender, age, place of residence, household type, and occupation of the user.

[6]

The user behavior evaluation device according to any one of [1] to [5], wherein the coefficient derivation portion derives a coefficient corresponding to a situation in which the user is placed.

[7]

The user behavior evaluation device according to [6], wherein the coefficient derivation portion derives a coefficient based on a movement means in a specific state of the user.

[8]

The user behavior evaluation device according to [7],
wherein the environmental impact calculation portion calculates an amount of environmental impact generated in a unit of movement,
wherein the coefficient derivation portion derives a coefficient in the unit of movement, and
wherein the behavior evaluation portion evaluates the behavior of the user in the unit of movement.
   [9]

The user behavior evaluation device according to any one of [1] to [8], wherein the coefficient derivation portion derives a coefficient corresponding to an amount of communication of the user when a contract for a predetermined plan, which is a communication plan, is made as the behavior of the user.

[10]

The user behavior evaluation device according to any one of [1] to [9], wherein the coefficient derivation portion derives a coefficient corresponding to the number of purchased products of a predetermined category as the behavior of the user.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

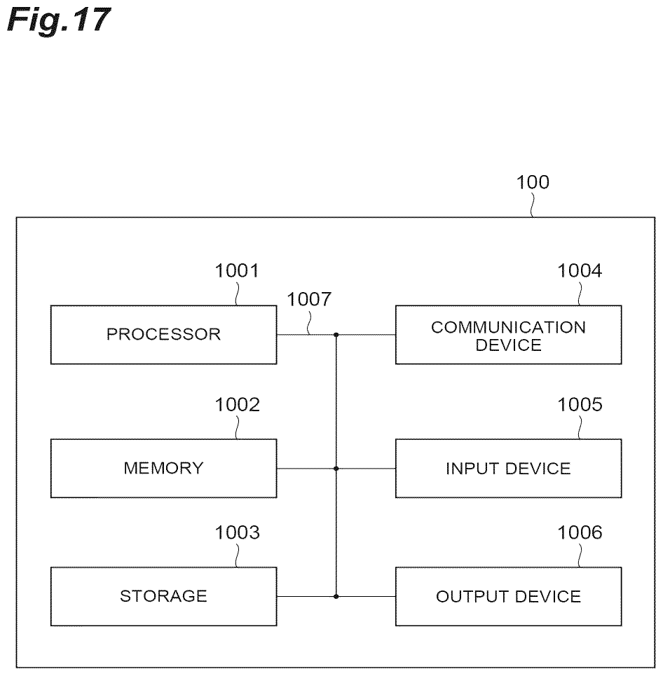

For example, the sustainable score calculation device 100 and the like according to one embodiment of the present disclosure may function as a computer that performs processing of a sustainable score calculation method or a conversation information generation method according to the present disclosure. FIG. 17 is a view showing an example of the hardware configuration of the sustainable score calculation device 100 according to one embodiment of the present disclosure. The sustainable score calculation device 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the sustainable score calculation device 100 may be configured to include one or a plurality of the devices shown in the drawings or may be configured without including some of those devices.

The functions of the sustainable score calculation device 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the request confirmation portion 102, the reduced-amount-of-emissions calculation portion 103 103 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the request confirmation portion 102, the search unit 103, and the conversation information generation unit 104 of the conversation device 100 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network a through telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing the sustainable score calculation method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described request reception portion 101 and score transmission portion 105 may be implemented by the communication device 1004. The communication device 1004 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the sustainable score calculation device 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 Sustainable score calculation device
101 Request reception portion
102 Request confirmation portion
103 Reduced-amount-of-emissions calculation portion
104 Score calculation portion
105 Score transmission portion

1. A user behavior evaluation device comprising:
an environmental impact calculation portion configured to calculate an amount of environmental impact generated in association with the behavior of a user;
a coefficient derivation portion configured to derive a coefficient on the basis of the user or the behavior of the user; and
a behavior evaluation portion configured to calculate an evaluation value for the behavior of the user on the basis of the generated amount and the coefficient.

2. The user behavior evaluation device according to claim 1,
wherein the environmental impact calculation portion further calculates a reduced amount of environmental impact on the basis of the generated amount, and
wherein the behavior evaluation portion further calculates the evaluation value on the basis of the reduced amount.

3. The user behavior evaluation device according to claim 1, wherein the behavior of the user includes at least one of movement of the user using a moving means, communication of a communication means used by the user, use of electricity by the user, and purchase behavior of the user.

4. The user behavior evaluation device according to claim 1, wherein the coefficient derivation portion derives a coefficient on the basis of attributes of the user.

5. The user behavior evaluation device according to claim 4, wherein the attributes include at least one of a gender, age, place of residence, household type, and occupation of the user.

6. The user behavior evaluation device according to claim 1, wherein the coefficient derivation portion derives a coefficient corresponding to a situation in which the user is placed.

7. The user behavior evaluation device according to claim 6, wherein the coefficient derivation portion derives a coefficient based on a movement means in a specific state of the user.

8. The user behavior evaluation device according to claim 7,
wherein the environmental impact calculation portion calculates an amount of environmental impact generated in a unit of movement,
wherein the coefficient derivation portion derives a coefficient in the unit of movement, and
wherein the behavior evaluation portion evaluates the behavior of the user in the unit of movement.

9. The user behavior evaluation device according to claim 1, wherein the coefficient derivation portion derives a coefficient corresponding to an amount of communication of the user when a contract for a predetermined plan, which is a communication plan, is made as the behavior of the user.

10. The user behavior evaluation device according to claim 1, wherein the coefficient derivation portion derives a coefficient corresponding to the number of purchased products of a predetermined category as the behavior of the user.
